(19) United States
(12) Patent Application Publication
(10) Pub. No.: US 2005/0285286 A1
(43) Pub. Date: Dec. 29, 2005

(54) Polarizer and method of producing the same, polarizing plate, optical film, and image display

(75) Inventors: Shunsuke Shuto, Osaka (JP); Tetsurou Ikeda, Osaka (JP); Naoki Tomoguchi, Osaka (JP); Yuuji Saiki, Osaka (JP); Takashi Misumi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/167,249

(22) Filed: Jun. 28, 2005

(30) Foreign Application Priority Data
Jun. 29, 2004 (JP) 2004-191763
May 10, 2005 (JP) 2005-137299

(51) Int. Cl. C08F 36/00

(52) U.S. Cl. 264/1.34; 524/557; 524/399

(57) ABSTRACT

The polarizer of invention comprises a zinc-containing polyvinyl alcohol-based film which has been subjected at least to dyeing with an iodine solution containing iodine and potassium iodide, wherein the polarizer has a value of zinc content (% by weight)/potassium content (% by weight) of from 0.05 to 0.4, and a potassium content of from 0.2 to 12% by weight, and a value of zinc content (% by weight)/iodine content (% by weight) of from 0.012 to less than 0.05, and an iodine content of from 1 to 20% by weight. The polarizer can achieve high resistance to humidity.

### BACKGROUND OF THE INVENTION

1. Field of the Invention

The invention relates to a polarizer and a method of producing the same. The invention further relates to a polarizing plate and an optical film using the polarizer. The invention still further relates to an image display such as a liquid crystal display, an organic EL display, and a PDP, using the polarizer, the polarizing plate or the optical film.

2. Description of the Related Art

Conventionally, an iodine-dyed polyvinyl alcohol film is used as polarizers for use in liquid crystal displays and the like because of having both high transmittance and degree of polarization. Such polarizers are generally used as a polarizing plate together with a protective film such as a triacetyl cellulose film attached to one or both sides thereof.

In recent years, liquid crystal displays have been widely used and thus can often be used under high temperature conditions or the like for a long time. Therefore, there has been a demand for liquid crystal displays that can suit their application with less change in hue. Accordingly, durability has been required of polarizing plates such that their optical characteristics are not degraded when they are allowed to stand under high temperature conditions or high temperature and high humidity conditions.

For example, it is disclosed that when an adequate amount of zinc ions is added to polarizers of iodine-dyed polyvinyl alcohol film, their durability can be improved (see Japanese Patent Application Laid-Open (JP-A) No. 54-16575, JP-A No. 61-175602 and JP-A No. 2000-35512 below). More specifically, it is disclosed that with respect to durability, red transit (transit of polarized light at long wavelength) can be prevented, which would otherwise occur at crossed Nicols particularly when polarizers are allowed to stand under high temperature conditions. However, using the polarizers disclosed in the above patent Literatures cannot sufficiently prevent blue transit (transit of polarized light at short wavelength), which would otherwise occur at crossed Nicols when they are allowed to stand under high temperature and high humidity conditions. Higher durability has been required of liquid crystal displays as their application field is extended.

### SUMMARY OF THE INVENTION

It is an object of the invention to provide a polyvinyl alcohol film polarizer that can have high resistance to humidity and to provide a method of producing such a polarizer.

It is another object of the invention to provide a polarizing plate using such a polarizer, to provide an optical film using such a polarizer or polarizing plate, and to provide an image display using such a polarizer, polarizing plate or optical film.

In order to solve the above problems, the present inventors have made active investigations and finally have found that the objects can be achieved by means of the polarizer as shown below or the method of producing the same in completing the invention.

Thus, the invention is directed to a polarizer, comprising a zinc-containing polyvinyl alcohol-based film which has been subjected at least to dyeing with an iodine solution containing iodine and potassium iodide, wherein

the polarizer has a value of zinc content (% by weight)/potassium content (% by weight) of from 0.05 to 0.4, and a potassium content of from 0.2 to 12% by weight,

and a value of zinc content (% by weight)/iodine content (% by weight) of from 0.012 to less than 0.05, and an iodine content of from 1 to 20% by weight.

The invention has been made based on the finding that, for improving the durability of a polarizer, the ratio of the zinc content to the potassium content is a more important parameter than the zinc content itself of the polyvinyl alcohol-based film and that the content of potassium in the polarizer is also a more important parameter. According to the invention, therefore, the value of zinc content (% by weight)/potassium content (% by weight) and the potassium content are adjusted in the above ranges, respectively, so that a polarizer with high resistance to humidity can be obtained.

In order to produce a polarizer with higher resistance to humidity, an adjustment is performed such that the value of zinc content (% by weight)/potassium content (% by weight) is from 0.05 to 0.4. The value of zinc content (% by weight)/potassium content (% by weight) is preferably from 0.05 to 0.27, more preferably from 0.05 to 0.23, still more preferably from 0.05 to 0.2, yet more preferably from 0.08 to 0.19, most preferably from 0.14 to 0.19. The content of potassium in the polarizer is from 0.2 to 12% by weight, preferably from 0.3 to 8% by weight, sill more preferably from 0.4 to 2% by weight, most preferably from 0.4 to 1% by weight.

The invention has also been made based on the finding that, for improving the durability of a polarizer, the ratio of the zinc content to the iodine content is a more important parameter than the zinc content itself of the polyvinyl alcohol-based film and that the content of iodine in the polarizer is also a more important parameter. According to the invention, therefore, the value of the zinc content (% by weight)/iodine content (% by weight) and the iodine content are adjusted in the above ranges, respectively, so that a polarizer with high resistance to humidity can be obtained.

In order to produce a polarizer with higher resistance to humidity, an adjustment is performed such that the value of the zinc content (% by weight)/iodine content (% by weight) is from 0.012 to less than 0.05. The value of the zinc content (% by weight)/iodine content (% by weight) is preferably from 0.012 to 0.04, more preferably from 0.012 to 0.036, still more preferably from 0.018 to 0.036, yet more preferably from 0.020 to 0.035, most preferably from 0.025 to 0.035. The content of iodine in the polarizer is from 1 to 20% by weight, preferably from 1 to 12% by weight, sill more preferably from 2 to 8% by weight, yet more preferably from 2 to 6% by weight, most preferably from 2 to 4% by weight.

The content of zinc in the polarizer may be adjusted so as to provide the above ratio in the range of from 0.03 to 0.7% by weight, preferably from 0.03 to 0.4% by weight, still more preferably from 0.03 to 0.2% by weight, most preferably from 0.04 to 0.1% by weight.

In the invention, the value of zinc content/potassium content, the potassium content, the value of zinc content/iodine content, and the iodine content should preferably satisfy the requirements of the above ranges, respectively, in terms of not only high resistance to humidity but also hue neutrality.

The invention is also directed to a method of producing the above polarizer, comprising at least the steps of performing to a polyvinyl alcohol-based film: uniaxial stretching; iodine dyeing with an iodine solution containing iodine and potassium iodide; zinc impregnating with a zinc salt solution; and washing with a potassium iodide solution after the above steps, wherein the zinc salt solution has a zinc ion concentration (B) of from 0.16 to 1% by weight in the zinc impregnating step, and (A), (B) and (C) are adjusted so as to satisfy the formula:
(B/A)+6>C>−3×(B/A)+5.5
wherein (A) represents a potassium iodide concentration (% by weight) of the iodine solution in the iodine dyeing step, (B) represents a zinc ion concentration (% by weight) of the zinc salt solution in the zinc impregnating step, and (C) represents a potassium iodide concentration (% by weight) of the potassium iodide solution in the washing step.

In the method of the invention, the zinc salt solution used has a zinc ion concentration (B) of from 0.16 to 1% by weight in the zinc impregnating step, and the potassium iodide concentration (C) of the potassium iodide solution in the washing step is adjusted so as to satisfy the above formula depending on the ratio ((B)/(A)) of the zinc ion concentration (B) to the potassium iodide concentration (A) of the iodine solution in the iodine dyeing step, so that the value of zinc content/potassium content, the potassium content, the value of zinc content/iodine content, and the iodine content are adjusted in the above ranges, respectively, in the polarizer. In the present method, the value of (B)/(A) is generally adjusted in the range of from about 0.3 to about 6, preferably from 0.4 to 4.

The invention is also directed to a polarizing plate, comprising the above polarizer and a transparent protective layer formed on at least one side of the polarizer.

The polarizing plate preferably has a color difference ΔEab_{80/90-120} of 5 or less, wherein ΔEab_{80/90-120} is defined by the following formula:
ΔEab_{80/90-120}={(L₁₂₀−L₀)²+(a₁₂₀−a₀)²+(b₁₂₀−b₀)²}^{1/2}
wherein (L₀,a₀,b₀) is an initial chromaticity in an perpendicular state, (L₁₂₀,a₁₂₀,b₁₂₀) is a chromaticity after the polarizing plate is allowed to stand under the conditions of 80° C. and 90% RH for 120 hours, and the L value, the a value and the b value are according to the Hunter color system.

In the polarizing plate with a color difference ΔEab_{80/90-120} of 5 or less, the change in chromaticity can be small and the resistance to humidity can be high even under high temperature and high humidity conditions. The color difference ΔEab_{80/90-120} is preferably 3 or less, more preferably 1 or less.

The invention is also directed to an optical film, comprising at least the above polarizer or the above polarizing plate.

The invention is also directed to an image display, comprising at least the above polarizer, the above polarizing plate or the above optical film.

### BRIEF DESCRIPTION OF THE DRAWINGS

FIG. 1 is a chart showing the relationship between the value of zinc content (% by weight)/potassium content (%by weight) and the color difference ΔEab;

FIG. 2 is a chart showing the relationship between the value of zinc content (% by weight)/iodine content (% by weight)and the color difference ΔEab; and

FIG. 3 is a chart showing the relationship between the value of zinc content (% by weight)/potassium content (% by weight) and Δb.

### DESCRIPTION OF THE PREFERRED EXAMPLES

Polyvinyl alcohol or any derivative thereof may be used as a material for the polyvinyl alcohol-based film suited for the polarizer of the invention. Examples of the polyvinyl alcohol derivative include polyvinyl formal, polyvinyl acetal, and those modified with an olefin such as ethylene and propylene, an unsaturated carboxylic acid such as acrylic acid, methacrylic acid and crotonic acid, an alkyl ester thereof, acrylamide, or the like. The polyvinyl alcohol generally has a degree of polymerization of from about 1,000 to about 10,000 and a saponification degree of from about 80 to about 100% by mole.

The polyvinyl alcohol-based film may contain any additive such as a plasticizer. Examples of the plasticizer include polyols and condensation products thereof, such as glycerol, diglycerol, triglycerol, ethylene glycol, propylene glycol, and polyethylene glycol. While the plasticizer may be used in any amount, the content of the plasticizer in the polyvinyl alcohol-based film is preferably 20% by weight or less.

The polarizer of the invention may be produced by any method that can achieve a zinc value of content (% by weight)/potassium content (% by weight) of from 0.05 to 0.27, a potassium content of from 0.2 to 12% by weight, a value of zinc content (% by weight)/iodine content (% by weight) of from 0.012 to less than 0.05, and an iodine content of from 1 to 20% by weight in the resulting polarizer.

The polarizer of the invention can be produced by subjecting the polyvinyl alcohol-based film (unstretched film) to at least a uniaxial stretching step, an iodine dyeing step, and a zinc impregnating step, according to conventional methods. In addition, a boric acid treatment or a washing step using a potassium iodide solution may be performed. The processed polyvinyl alcohol-based film (stretched film) may be dried according to conventional methods so that a finished polarizer can be obtained.

For example, the polarizer of the invention may be obtained by subjecting the polyvinyl alcohol-based film (un stretched film) to a uniaxial stretching step, an iodine dyeing step and a zinc impregnating step and then performing a washing step with a potassium iodide solution, in such a manner that the concentration of the solution in each step is controlled so as to provide a zinc ion concentration(B) of from 0.16 to 1% by weight in the zinc impregnating step and so as to satisfy the formula:
−(B/A)+6>C>−3×(B/A)+5.5
wherein (A) represents a potassium iodide concentration (% by weight) of the iodine solution in the iodine dyeing step, (B) represents a zinc ion concentration (% by weight) of the zinc salt solution in the zinc impregnating step, and (C) represents a potassium iodide concentration (% by weight) of the potassium iodide solution in the washing step.

In the uniaxial stretching step, any stretching method, for example, any of a wet stretching method and a dry stretching method may be used, while a wet stretching method is preferably used. For example, the wet stretching method generally includes the steps of feeding a polyvinyl alcohol-based film (raw film) through guide rolls and immersing it in a swelling bath, swelling and stretching the polymer film, subsequently immersing it in an iodine solution containing iodine and potassium iodide to dye it, and further stretching it while immersing it in a crosslinking bath. Examples of dry stretching methods include stretching between rolls, heating roll stretching, and compression stretching. In the dry stretching method, the unstretched film is generally heated. The stretching may be performed in a multistage manner.

In general, unstretched film having a thickness of approximately 30 to 150 μm is used. While the film may be stretched at any proper stretch ratio depending on purpose, the stretch ratio (total stretch ratio) may be from about 2 to about 7, preferably from 3 to 6.5, more preferably from 3.5 to 6. The stretched film preferably has a thickness of 5 to 40 μm.

The iodine dyeing step may be performed by immersing the polyvinyl alcohol-based film in the iodine solution containing iodine and potassium iodide. The iodine solution is generally an aqueous iodine solution which contains iodine and potassium iodide as an auxiliary agent. While the iodine may be at any concentration, the iodine concentration may be from about 0.01 to about 1% by weight, preferably from 0.02 to 0.5% by weight. While the potassium iodide may be at any concentration, the potassium iodide concentration (A) may be from about 0.01 to about 10% by weight, preferably from 0.02 to 3% by weight, more preferably from 0.04 to 1% by weight, still more preferably from 0.1 to 1% by weight, most preferably from 0.2 to 0.6% by weight.

In the iodine dyeing step, the iodine solution generally has a temperature of from about 20 to about 50° C., preferably from 25 to 40° C. The immersion time period is generally from about 10 to about 300 seconds, preferably from 20 to 240 seconds. In the iodine dyeing step, the conditions including the concentration of the iodine solution and the temperature and/or time period of the immersion of the polyvinyl alcohol-based film in the iodine solution may be controlled such that the contents of iodine and potassium in the polyvinyl alcohol-based film can be in the above ranges, respectively. The iodine dyeing step may be performed at any stage before the uniaxial stretching step, during the uniaxial stretching step, or after the uniaxial stretching step.

The boric acid treatment may be performed by immersing the polyvinyl alcohol-based film in an aqueous boric acid solution. The concentration of boric acid in the aqueous boric acid solution may be from about 2 to about 15% by weight, preferably from 3 to 10% by weight, more preferably from 3 to 6% by weight. The aqueous boric acid solution may contain potassium ions and iodine ions derived from potassium iodide. The concentration of potassium iodide in the aqueous boric acid solution may be from about 0.5 to about 10% by weight, preferably from 1 to 8% by weight, more preferably from 2 to 6% by weight. Using the aqueous boric acid solution containing potassium iodide, a so-called neutral gray polarizer can be produced which is less colored or substantially uniform in absorbance over substantially the entire range of visible light wavelengths.

In the boric acid treatment, the aqueous boric acid solution may have a temperature of 30° C. or higher, preferably from 40 to 85° C. The immersion time period is generally from about 1 to about 1,200 seconds, preferably from about 10 to about 600 seconds, more preferably from about 20 to about 500 seconds. The boric acid treatment may be performed after the iodine dyeing step. The boric acid treatment may also be performed during or after the uniaxial stretching step. The boric acid treatment may be performed plural times.

The zinc impregnating step uses a zinc salt solution, which is generally an aqueous solution. Examples of the zinc salt include zinc halide such as zinc chloride and zinc iodide, zinc sulfate, and zinc acetate. The concentration of zinc ion in the zinc salt solution may be any value but is generally from 0.16 to 1% by weight, preferably from 0.16 to 0.8% by weight, more preferably from 0.2 to 0.6% by weight, still more preferably from 0.2 to 0.5% by weight, most preferably from 0.2 to 0.4% by weight. The zinc ion concentration may be calculated by dividing the weight of the zinc ions in the zinc salt solution by the weight of the zinc salt solution. If the zinc salt is contained in the boric acid solution, the zinc ion concentration should be calculated as that in the boric acid solution.

The zinc salt solution is preferably used in the form of an aqueous solution containing potassium ions and iodine ions derived from potassium iodide or the like, because such a solution can facilitate the impregnation of zinc ions. The concentration of potassium iodide in the zinc salt solution may be from about 0.5 to about 10% by weight, preferably from 1 to 8% by weight, more preferably from 2 to 6% by weight.

In the zinc impregnating step, the zinc salt solution generally has a temperature of from about 15 to about 85° C., preferably from about 25 to about 70° C. The immersion time period is generally from about 1 to about 120 seconds, preferably from 3 to 90 seconds. In the zinc impregnating step, the conditions including the concentration of the zinc salt solution and the temperature and/or time period of the immersion of the polyvinyl alcohol-based film in the zinc salt solution may be controlled such that the zinc content of the polyvinyl alcohol-based film can be in the above range.

The zinc impregnating step may be performed at any stage, for example, before the iodine dyeing step, after the iodine dyeing step and before the immersion step in the aqueous boric acid solution, during the boric acid treatment, or after the boric acid treatment. The zinc impregnating step and the iodine dyeing step may be performed at the same time using the zinc salt present in the iodine dyeing solution. The zinc impregnating step is preferably performed together with the boric acid treatment. The uniaxial stretching step may be performed together with the zinc impregnating step. The zinc impregnating step may be performed plural times. When the zinc impregnating step is performed plural times in the above method, the zinc ion concentration (B) of the zinc salt solution, which defines the value of (B)/(A) with respect to the potassium iodide concentration (A), refers to the highest zinc ion concentration of the aqueous solutions among the plural steps.

The processed polyvinyl alcohol-based film (stretched film) may be subjected to a water-washing step and a drying step according to conventional methods.

In the method of producing the polarizer according to the invention, the washing step using the potassium iodide solution is preferably performed after the uniaxial stretching step, the iodine dyeing step, and the zinc impregnating step. The potassium iodide concentration (C) of the potassium iodide solution is generally from about 0.5 to about 10% by weight, from 0.5 to 8% by weight, or from 1 to 6% by weight and preferably controlled so as to satisfy the formula: −(B/A)+6>C>−3×(B/A)+5.5, depending on the value of (B)/(A).

In the washing step with the potassium iodide solution, the process temperature is generally from about 15 to about 60° C., preferably from 25 to 40° C. The immersion time period is generally from about 1 to about 120 seconds, preferably from 3 to 90 seconds. The washing step using the potassium iodide solution may be performed at any stage before the drying step.

The above description shows the washing step in which the potassium iodide concentration (C) of the potassium iodide solution is adjusted. Alternatively, however, the polarizer of the invention can be obtained without the control by the washing step with the potassium iodide solution. In such a case, the washing step in the potassium iodide solution is not particularly necessary, and a washing step using water may generally be performed.

The water washing step is generally performed by immersing the polyvinyl alcohol-based film in purified water such as ion-exchange water and distilled water. The water washing temperature is generally from 5 to 50° C., preferably from 10 to 45° C., more preferably from 15 to 40° C. The immersion time period is generally from about 10 to about 300 seconds, preferably from about 20 to about 240 seconds. The water washing step may also be performed before or after the washing step with the potassium iodide solution.

After the washing step, the drying step is generally performed at a temperature of from 20 to 70° C., preferably from 25 to 60° C., for about 3 to about 5 minutes.

The above-described polarizer may be used as a polarizing plate with a transparent protective layer prepared at least on one side thereof using a usual method. The transparent protective layer may be prepared as an application layer by polymers, or a laminated layer of films. Proper transparent materials may be used as a transparent polymer or a film material that forms the transparent protective film, and the material having outstanding transparency, mechanical strength, heat stability and outstanding moisture interception property, etc. may be preferably used. As materials of the above-mentioned protective layer, for example, polyester type polymers, such as polyethylene terephthalate and polyethylene naphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned. Films made of heat curing type or ultraviolet ray curing type resins, such as acryl based, urethane based, acryl urethane based, epoxy based, and silicone based, etc. may be mentioned. The transparent protective layer can be formed as a cured layer made of heat curing type or ultraviolet ray curing type resins, such as acryl based, urethane based, acryl urethane based, epoxy based, and silicone based.

Moreover, as is described in Japanese Patent Laid-Open Publication No.2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used. In these films, the retardation is small and the photoelastic coefficient is also small, and thus defects such as unevenness which would otherwise be caused by distortion of the polarizing plate can be prevented. In these films, the moisture permeability is also small, and thus they can have good durability under moistening conditions.

While the thickness of the transparent protective layer may be specified as needed, it should be from about 1 to about 500 μm generally in terms of strength, processibility such as handleability, and thin layer formability, preferably from 1 to 300 μm, more preferably from 5 to 200 μm, most preferably from 40 to 100 μm.

Moreover, it is preferable that the transparent protective layer may have as little coloring as possible. Accordingly, a protection film having a retardation value in a film thickness direction represented by Rth=(nx−ny)×d of from −90 nm to +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protection film may mostly be cancelled using a protection film having a retardation value (Rth) of from −90 nm to +75 nm in a thickness direction. The retardation value (Rth) in a thickness direction is preferably from −80 nm to +60 nm, and especially preferably from −70 nm to +45 nm.

In terms of polarization characteristics and durability, the protective film preferably comprises a cellulose-based polymer such as triacetyl cellulose. A triacetyl cellulose film is particularly preferred. The protective film such as a triacetyl cellulose film can have a relatively large retardation Rth in the thickness direction and thus can cause a problem of discoloration. A resin composition containing an alternating copolymer composed of isobutylene and N-methylmaleimide and an acrylonitrile-styrene copolymer can have a retardation Rth of 30 nm or less in the thickness direction and thus can be substantially free from discoloration. If the transparent protective layers are provided on both sides of the polarizer, the front and back transparent protective layers may comprise the same polymer material or different polymer materials.

A hard coat layer may be prepared, or antireflection processing, processing aiming at sticking prevention, diffusion or anti glare may be performed onto the face on which the polarizer of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the transparent protective layer using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the transparent protective layer using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the transparent protective layer itself, and also they may be prepared as an optical layer different from the transparent protective layer.

Adhesives are used for adhesion processing of the above described polarizing film and the transparent protective layer. As adhesives, isocyanate derived adhesives, polyvinyl alcohol derived adhesives, gelatin derived adhesives, vinyl polymers derived latex type, aqueous polyesters derived adhesives, etc. may be mentioned. The above-described adhesives are usually used as adhesives comprising aqueous solution, and usually contain solid of 0.5 to 60% by weight.

A polarizing plate of the present invention is manufactured by adhering the above-described transparent protective film and the polarizing film using the above-described adhesives. The application of adhesives may be performed to any of the transparent protective film or the polarizing film, and may be performed to both of them. After adhered, drying process is given and the adhesion layer comprising applied dry layer is formed. Adhering process of the polarizing film and the transparent protective film may be performed using a roll laminator etc. Although a thickness of the adhesion layer is not especially limited, it is usually approximately from 30 to 1000 nm.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transreflective plate, a retardation plate (a half wavelength plate and a quarter wavelength plate included), and a viewing angle compensation film, may be used. Especially preferable polarizing plates are; a reflection type polarizing plate or a transreflective type polarizing plate in which a reflector or a transreflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

In addition, a transreflective type polarizing plate may be obtained by preparing the above-mentioned reflective layer as a transreflective type reflective layer, such as a half-mirror etc. that reflects and transmits light. A transreflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transreflective type polarizing plate.

The above-mentioned polarizing plate may be used as elliptically polarizing plate or circularly polarizing plate on which the retardation plate is laminated. A description of the above-mentioned elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced, when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyallylates and polyamides; aligned films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or perpendicular biaxial stretching and a biaxial stretched film as inclined alignment film etc. may be used. As inclined alignment film, for example, a film obtained using a method in which a heat shrinking film is adhered to a polymer film, and then the combined film is heated and stretched or shrinked under a condition of being influenced by a shrinking force, or a film that is aligned in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a semi-transmission type elliptically polarizing plate, etc. in which the above-mentioned reflection type polarizing plate or a transreflective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

An optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, optical films and, if necessity, lighting system, and by incorporating driving circuit. In the present invention, except that an optical film by the present invention is used, there is especially no limitation to use any conventional methods. Also any liquid crystal cell of arbitrary type, such as TN type, and STN type, π type may be used.

Suitable liquid crystal displays, such as liquid crystal display with which the above-mentioned optical film has been located at one side or both sides of the liquid crystal cell, and with which a backlight or a reflector is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic emitting layer and a metal electrode are laminated on a transparent substrate in an order configuring an illuminant (organic electro luminescence illuminant). Here, an organic emitting layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

In an organic EL display containing an organic electro luminescence illuminant equipped with a transparent electrode on a surface side of an organic emitting layer that emits light by impression of voltage, and at the same time equipped with a metal electrode on a back side of organic emitting layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

### EXAMPLES

The invention is more specifically described by means of Examples and Comparative Examples below. In each example, “%” means % by weight.

### Example 1

A 75 μm-thick polyvinyl alcohol film (with an average degree of polymerization of 2,400 and a saponification degree of 99.9%) of was swelled in water at 30° C. and uniaxially stretched in water (at a stretch ratio of 3 times), and then immersed at 30° C. for 60 seconds in an aqueous iodine solution with a potassium iodide concentration of 0.35% and an iodine concentration of 0.05% so that it was dyed. The film was then immersed at 40° C. for 45 seconds in a first aqueous boric acid solution with a boric acid concentration of 3%, a potassium iodide concentration of 3% and a zinc sulfate heptahydrate concentration of 0.6%, and then stretched to 6 times while immersed at 60° C. for 30 seconds in a second aqueous boric acid solution with a boric acid concentration of 5.7%, a potassium iodide concentration of 5% and a zinc sulfate heptahydrate concentration of 0.6%. The film was then immersed at 30° C. for 10 seconds in a 5% aqueous potassium iodide solution. The film was then dried at 50° C. for 4 minutes to give a polarizer. Surface-saponified 80 μm-thick triacetyl cellulose films of were adhered to both sides of the resulting polarizer with a polyvinyl alcohol-based adhesive and then dried at 60° C. for 4 minutes to form a polarizing plate.

### Example 2

A polarizer and a polarizing plate were obtained using the process of Example 1 except that the concentrations of potassium iodide and iodine in the aqueous iodine solution were adjusted to 0.28% and 0.04%, respectively.

### Example 3

A polarizer and a polarizing plate were obtained using the process of Example 1 except that the concentrations of potassium iodide and iodine in the aqueous iodine solution were adjusted to 0.3% and 0.043%, respectively.

### Comparative Example 1

A polarizer and a polarizing plate were obtained using the process of Example 1 except that neither the first nor the second aqueous boric acid solutions were contained zinc sulfate heptahydrate.

### Comparative Example 2

A polarizer and a polarizing plate were obtained using the process of Example 1 except that the concentration of zinc sulfate heptahydrate in each of the first and second boric acid solutions was adjusted to 0.3%.

### Comparative Example 3

A polarizer and a polarizing plate were obtained using the process of Example 1 except that the concentration of zinc sulfate heptahydrate in each of the first and second boric acid solutions was adjusted to 2.5%.

### Comparative Example 4

A polarizer and a polarizing plate were obtained using the process of Example 1 except that the concentration of zinc sulfate heptahydrate in each of the first and second boric acid solutions was adjusted to 4.5%.

### Comparative Example 5

A polarizer and a polarizing plate were obtained using the process of Example 1 except that the concentration of zinc sulfate heptahydrate in each of the first and second boric acid solutions was adjusted to 6.5%.

### Comparative Example 6

A 75 μm-thick polyvinyl alcohol film (with an average degree of polymerization of 2,400 and a saponification degree of 99.9%) was uniaxially stretched by a dry step (at a stretch ratio of 5 times) and then immersed at 28° C. for 60 seconds in an aqueous iodine solution with a potassium iodide concentration of 4.76% and an iodine concentration of 0.05% while kept in a state of tension, so that it was dyed. The film was then immersed at 76° C. for 300 seconds in an aqueous boric acid solution with a boric acid concentration of 6.47%, a potassium iodide concentration of 5.17% and a zinc chloride concentration of 2.16%. The film was then washed with purified water at 15° C. for 10 seconds and then dried at 50° C. to give an about 20 μm-thick polarizer. A polarizing plate was then obtained using the process of Example 1.

### Comparative Example 7

A polarizer and a polarizing plate were obtained using the process of Comparative Example 6 except that the aqueous boric acid solution used had a boric acid concentration of 6.54%, a potassium iodide concentration of 5.23% and a zinc chloride concentration of 1.09%.

### Example 11

A 75 μm-thick polyvinyl alcohol film (with an average degree of polymerization of 2400 and a saponification degree of 99.9%) was swelled in water at 30° C. and uniaxially stretched in water (at a stretch ratio of 3 times), and then immersed at 30° C. for 60 seconds in an aqueous iodine solution with a potassium iodide concentration of 0.25% and an iodine concentration of 0.035% so that it was dyed. The film was then immersed at 40° C. for 30 seconds in a first aqueous boric acid solution with a boric acid concentration of 3%, a potassium iodide concentration of 3% and a zinc sulfate heptahydrate concentration of 1.0%, and then stretched to 6 times while immersed at 60° C. for 60 seconds in a second aqueous boric acid solution with a boric acid concentration of 4%, a potassium iodide concentration of 5% and a zinc sulfate heptahydrate concentration of 1%. The film was then immersed at 30° C. for 10 seconds in a 2% aqueous potassium iodide solution for washing it. The film was then dried at 70° C. for 2 minutes to give a polarizer. Surface-saponified 80 μm-thick triacetyl cellulose films were adhered to both sides of the resulting polarizer with a polyvinyl alcohol-based adhesive and then dried at 60° C. for 4 minutes to form a polarizing plate.

### Example 12

A polarizer and a polarizing plate were obtained using the process of Example 11 except that a 3% aqueous potassium iodide solution was alternatively used for washing.

### Example 13

A polarizer and a polarizing plate were obtained using the process of Example 11 except that the concentration of zinc sulfate heptahydrate in each of the first and second aqueous boric acid solutions was alternatively set at 1.5%.

### Example 14

A polarizer and a polarizing plate were obtained using the process of Example 11 except that the concentration of zinc sulfate heptahydrate in each of the first and second aqueous boric acid solutions was alternatively set at 1.5% and that a 4% aqueous potassium iodide solution was alternatively used for washing.

### Example 15

A polarizer and a polarizing plate were obtained using the process of Example 11 except that the concentration of zinc sulfate heptahydrate in each of the first and second aqueous boric acid solutions was alternatively set at 2%.

### Example 16

A polarizer and a polarizing plate were obtained using the process of Example 11 except that the concentration of zinc sulfate heptahydrate in each of the first and second aqueous boric acid solutions was alternatively set at 3%.

### Example 17

A polarizer and a polarizing plate were obtained using the process of Example 11 except that the concentration of zinc sulfate heptahydrate in each of the first and second aqueous boric acid solutions was alternatively set at 2% and that a 1% aqueous potassium iodide solution was alternatively used for washing.

### Comparative Example 11

A polarizer and a polarizing plate were obtained using the process of Example 11 except that the concentration of zinc sulfate heptahydrate in each of the first and second aqueous boric acid solutions was alternatively set at 0%.

### Comparative Example 12

A polarizer and a polarizing plate were obtained using the process of Example 11 except that the concentration of zinc sulfate heptahydrate in each of the first and second aqueous boric acid solutions was alternatively set at 0.5% and that a 0% aqueous potassium iodide solution was alternatively used for washing.

### Comparative Example 13

A polarizer and a polarizing plate were obtained using the process of Example 11 except that the concentration of zinc sulfate heptahydrate in each of the first and second aqueous boric acid solutions was alternatively set at 0.5% and that a 4% aqueous potassium iodide solution was alternatively used for washing.

### Comparative Example 14

A polarizer and a polarizing plate were obtained using the process of Example 11 except that a 0% aqueous potassium iodide solution was alternatively used for washing.

### Comparative Example 15

A polarizer and a polarizing plate were obtained using the process of Example 11 except that a 5% aqueous potassium iodide solution was alternatively used for washing.

### Comparative Example 16

A polarizer and a polarizing plate were obtained using the process of Example 11 except that the concentration of zinc sulfate heptahydrate in each of the first and second aqueous boric acid solutions was alternatively set at 1.5% and that a 0% aqueous potassium iodide solution was alternatively used for washing.

The concentration of each component in each bath in each of Examples and Comparative Examples is shown in Table 1. Each concentration is the % ratio of the weight of each component to that of each solution. The zinc ion concentration was derived from the zinc (molecular weight: 65.4) content of the zinc salt. When the zinc salt is zinc sulfate heptahydrate (molecular weight: 223.4), the value of the zinc ion concentration is calculated by multiplying the zinc salt concentration by 0.293 (=65.4/223.4). When the zinc salt is zinc chloride (molecular weight: 136.4), the value of the zinc ion concentration is calculated by multiplying the zinc salt concentration by 0.479 (=65.4/136.4). Table 2 shows the relationship between the potassium iodide (KI) concentration (A) in the iodine solution, the zinc ion concentration (B) and the potassium iodide (KI) concentration (C) in the washing step.

TABLE 1

| | | | Second Bath | | | | |
|---|---|---|---|---|---|---|---|
| | First Bath | | (First Aqueous Boric Acid Solution) | | | | |
| | (Aqueous Iodine | | | | Zinc Salt | | |
| | Solution) | | Boric | | | | (B): Zinc |
| | (A): KI | Iodine | Acid | KI | | | Ion |
| | Concentra- | Concentra- | Concentra- | Concentra- | | Concentra- | Concentra- |
| | tion (%) | tion (%) | tion (%) | tion (%) | Type | tion (%) | tion (%) |
| Example 1 | 0.35 | 0.05 | 3 | 3 | Zinc | 0.6 | 0.176 |
| | | | | | Sulfate | | |
| Example 2 | 0.28 | 0.04 | 3 | 3 | Zinc | 0.6 | 0.176 |
| | | | | | Sulfate | | |
| Example 3 | 0.30 | 0.043 | 3 | 3 | Zinc | 0.6 | 0.176 |
| | | | | | Sulfate | | |
| Comparative | 0.35 | 0.05 | 3 | 3 | — | 0 | 0 |
| Example 1 | | | | | | | |
| Comparative | 0.35 | 0.05 | 3 | 3 | Zinc | 0.3 | 0.088 |
| Example 2 | | | | | Sulfate | | |
| Comparative | 0.35 | 0.05 | 3 | 3 | Zinc | 2.5 | 0.732 |
| Example 3 | | | | | Sulfate | | |
| Comparative | 0.35 | 0.05 | 3 | 3 | Zinc | 4.5 | 1.318 |
| Example 4 | | | | | Sulfate | | |
| Comparative | 0.35 | 0.05 | 3 | 3 | Zinc | 6.5 | 1.904 |
| Example 5 | | | | | Sulfate | | |
| Comparative | 4.76 | 0.05 | 6.47 | 5.17 | Zinc | 2.16 | 1.034 |
| Example 6 | | | | | Chloride | | |
| Comparative | 4.76 | 0.05 | 6.54 | 5.23 | Zinc | 1.09 | 0.522 |
| Example 7 | | | | | Chloride | | |
| Example 11 | 0.25 | 0.035 | 3 | 3 | Zinc | 1 | 0.298 |
| | | | | | Sulfate | | |
| Example 12 | 0.25 | 0.035 | 3 | 3 | Zinc | 1 | 0.298 |
| | | | | | Sulfate | | |
| Example 13 | 0.25 | 0.035 | 3 | 3 | Zinc | 1.5 | 0.447 |
| | | | | | Sulfate | | |
| Example 14 | 0.25 | 0.035 | 3 | 3 | Zinc | 1.5 | 0.447 |
| | | | | | Sulfate | | |
| Example 15 | 0.25 | 0.035 | 3 | 3 | Zinc | 2 | 0.586 |
| | | | | | Sulfate | | |
| Example 16 | 0.25 | 0.035 | 3 | 3 | Zinc | 3 | 0.879 |
| | | | | | Sulfate | | |
| Example 17 | 0.25 | 0.035 | 3 | 3 | Zinc | 2 | 0.586 |
| | | | | | Sulfate | | |
| Comparative | 0.25 | 0.035 | 3 | 3 | — | 0 | 0 |
| Example 11 | | | | | | | |
| Comparative | 0.25 | 0.035 | 3 | 3 | Zinc | 0.5 | 0.147 |
| Example 12 | | | | | Sulfate | | |
| Comparative | 0.25 | 0.035 | 3 | 3 | Zinc | 0.5 | 0.147 |
| Example 13 | | | | | Sulfate | | |
| Comparative | 0.25 | 0.035 | 3 | 3 | Zinc | 1 | 0.298 |
| Example 14 | | | | | Sulfate | | |
| Comparative | 0.25 | 0.035 | 3 | 3 | Zinc | 1 | 0.298 |
| Example 15 | | | | | Sulfate | | |
| Comparative | 0.25 | 0.035 | 3 | 3 | Zinc | 1.5 | 0.447 |
| Example 16 | | | | | Sulfate | | |

| | | | | | | Washing |
|---|---|---|---|---|---|---|
| | Second Bath | | | | | Bath |
| | (Second Aqueous Boric Acid Solution) | | | | | (Aqueous KI |
| | | | Zinc Salt | | | Solution) |
| | Boric Acid | KI | | | Zinc Ion | (C): KI |
| | Concentration | Concentration | | Concentra- | Concentra- | Concentra- |
| | (%) | (%) | Type | tion (%) | tion (%) | tion (%) |
| Example 1 | 5.7 | 5 | Zinc | 0.6 | 0.176 | 5 |
| | | | Sulfate | | | |
| Example 2 | 5.7 | 5 | Zinc | 0.6 | 0.176 | 5 |
| | | | Sulfate | | | |
| Example 3 | 5.7 | 5 | Zinc | 0.6 | 0.176 | 5 |
| | | | Sulfate | | | |
| Comparative | 5.7 | 5 | — | 0 | 0 | 5 |
| Example 1 | | | | | | |
| Comparative | 5.7 | 5 | Zinc | 0.3 | 0.088 | 5 |
| Example 2 | | | Sulfate | | | |
| Comparative | 5.7 | 5 | Zinc | 2.5 | 0.732 | 5 |
| Example 3 | | | Sulfate | | | |
| Comparative | 5.7 | 5 | Zinc | 4.5 | 1.318 | 5 |
| Example 4 | | | Sulfate | | | |
| Comparative | 5.7 | 5 | Zinc | 6.5 | 1.904 | 5 |
| Example 5 | | | Sulfate | | | |
| Comparative | 0 | 0 | — | 0 | 0 | 0 |
| Example 6 | | | | | | |
| Comparative | 0 | 0 | — | 0 | 0 | 0 |
| Example 7 | | | | | | |
| Example 11 | 4 | 5 | Zinc | 1 | 0.298 | 2 |
| | | | Sulfate | | | |
| Example 12 | 4 | 5 | Zinc | 1 | 0.298 | 3 |
| | | | Sulfate | | | |
| Example 13 | 4 | 5 | Zinc | 1.5 | 0.447 | 2 |
| | | | Sulfate | | | |
| Example 14 | 4 | 5 | Zinc | 1.5 | 0.447 | 4 |
| | | | Sulfate | | | |
| Example 15 | 4 | 5 | Zinc | 2 | 0.586 | 2 |
| | | | Sulfate | | | |
| Example 16 | 4 | 5 | Zinc | 3 | 0.879 | 2 |
| | | | Sulfate | | | |
| Example 17 | 4 | 5 | Zinc | 2 | 0.566 | 1 |
| | | | Sulfate | | | |
| Comparative | 4 | 5 | — | 0 | 0 | 2 |
| Example 11 | | | | | | |
| Comparative | 4 | 5 | Zinc | 0.5 | 0.147 | 0 |
| Example 12 | | | Sulfate | | | |
| Comparative | 4 | 5 | Zinc | 0.5 | 0.147 | 4 |
| Example 13 | | | Sulfate | | | |
| Comparative | 4 | 5 | Zinc | 1 | 0.298 | 0 |
| Example 14 | | | Sulfate | | | |
| Comparative | 4 | 5 | Zinc | 1 | 0.298 | 5 |
| Example 15 | | | Sulfate | | | |
| Comparative | 4 | 5 | Zinc | 1.5 | 0.447 | 0 |
| Example 16 | | | Sulfate | | | |

TABLE 2

| | (B)/(A) | −(B/A) + 6 | (C) | −3 × (B/A) + 5.5 |
|---|---|---|---|---|
| Example 1 | 0.50 | 5.5 | 5 | 4 |
| Example 2 | 0.62 | 5.38 | 5 | 3.64 |
| Example 3 | 0.59 | 5.41 | 5 | 3.73 |
| Comparative | 0 | 6 | 5 | 5.5 |
| Example 1 | | | | |
| Comparative | 0.25 | 5.75 | 5 | 4.75 |
| Example 2 | | | | |
| Comparative | 2.O9 | 3.91 | 5 | −0.77 |
| Example 3 | | | | |
| Comparative | 3.77 | 2.23 | 5 | −5.81 |
| Example 4 | | | | |
| Comparative | 5.44 | 0.56 | 5 | −10.82 |
| Example 5 | | | | |
| Comparative | 0.21 | 5.79 | 0 | 4.87 |
| Example 6 | | | | |
| Comparative | 0.11 | 5.89 | 0 | 5.17 |
| Example 7 | | | | |
| Example 11 | 1.19 | 4.81 | 2 | 1.93 |
| Example 12 | 1.19 | 4.81 | 3 | 1.93 |
| Example 13 | 1.79 | 4.21 | 2 | 0.13 |
| Example 14 | 1.79 | 4.21 | 4 | 0.13 |
| Example 15 | 2.34 | 3.66 | 2 | −1.52 |
| Example 16 | 3.52 | 2.48 | 2 | −5.06 |
| Example 17 | 2.34 | 3.66 | 1 | −1.52 |
| Comparative | 0 | 6 | 2 | 5.5 |
| Example 11 | | | | |
| Comparative | 0.59 | 5.41 | 0 | 3.73 |
| Example 12 | | | | |
| Comparative | 0.59 | 5.41 | 4 | 3.73 |
| Example 13 | | | | |
| Comparative | 1.19 | 4.81 | 0 | 1.93 |
| Example 14 | | | | |
| Comparative | 1.19 | 4.81 | 5 | 1.93 |
| Example 15 | | | | |
| Comparative | 1.79 | 4.21 | 0 | 0.13 |
| Example 16 | | | | |

The polarizers and the polarizing plates obtained in Examples and Comparative Examples were evaluated as described below.

[Chemical Composition Analysis]

Fluorescent X-ray analysis (ZSX manufactured by Rigaku Corporation) was performed to determine the zinc content (%), potassium content (%) and iodine content (%) of each polarizer prepared in each of Examples and Comparative Examples. The value of zinc content (%)/potassium content (%) and the value of zinc content (%)/iodine content (%) were calculated from the measurements. Table 3 shows the results of Examples 1 to 3 and Comparative Examples 1 to 7, and Table 4 shows the results of Examples 11 to 17 and Comparative Examples 11 to 16.

[Evaluations of High-Temperature and High-Humidity Durability on Examples 1 to 3 and Comparative Examples 1 to 5]

The polarizing plate was allowed to stand under the conditions of 80° C. and 90% RH for 120 hours, and then its color difference ΔEab_{80/90-120} was determined. The color difference ΔEab in the perpendicular state was determined using the initial chromaticity (L₀,a₀,b₀) in the perpendicular state and the chromaticity (L₁₂₀,a₁₂₀,b₁₂₀) in the perpendicular state after standing under the conditions of 80° C. and 90% RH for 120 hours according to the following formula: ΔEab_{90/90-120}={(L₁₂₀−L₀)²+(a₁₂₀−a₀)²+(b₁₂₀−b₀)²}^{1/2}. The L, a value and the b value are according to the Hunter color system. The results are shown in Table 3.

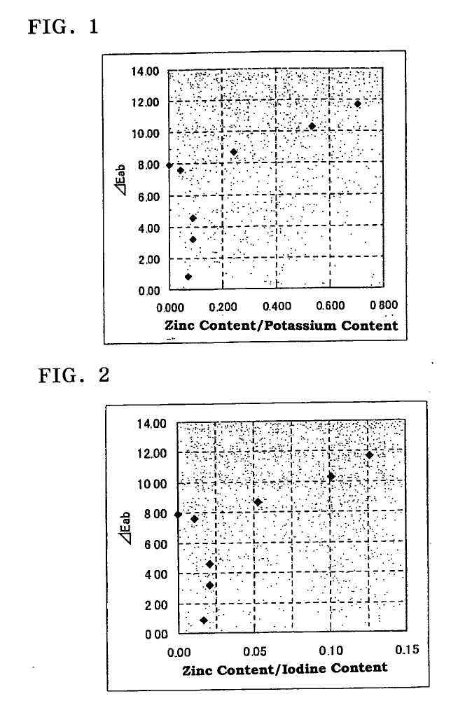

FIGS. 1 and 2 show the relationship between the value of zinc content (%)/potassium content (%) and the color difference ΔEab_{80/90-120}, and the relationship between the value of zinc content (%)/iodine content (%) and the color difference ΔEab_{80/90-120}, respectively.

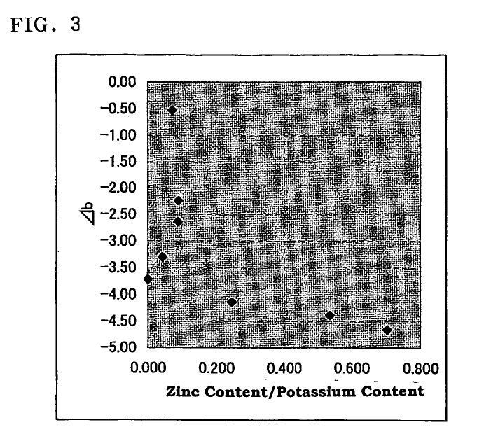

Blue transit was also evaluated. The blue transit is expressed by Δb=b₁₂₀−b₀, wherein b₁₂₀ and b₀ have the same meanings as defined above. The results are shown in Table 3. The greater the negative value of Δb, the larger the blue transit. If Δb<-3, blue transit can be visually observed. Thus, −3≦b≦0 is preferred. In polarizing plates (polarizers) that provide Δb in this range, the change in chromaticity can be small and blue transit can also be small, even under high temperature and high humidity conditions. Δb is preferably −1 or more, more preferably −0.6 or more. FIG. 3 shows the relationship between the value of zinc content (%)/potassium content (%) and Δb.

[Evaluations of High-Temperature Durability on Comparative Examples 6 and 7]

The polarizing plate was allowed to stand at 100° C. for 24 hours, and then its color difference ΔEab₁₀₀ was determined. The color difference ΔEab in the perpendicular state was determined using the initial chromaticity (L₀,a₀,b₀) in the perpendicular state and the chromaticity (L₂₄,a₂₄,b₂₄) in the perpendicular state after standing at 100° C. for 24 hours according to the following formula: ΔEab₁₀₀={(L₂₄−L₀)²+(a₂₄-a₀)²+(b₂₄−b₀)²}^{1/2}. The L value, the a value and the b value are according to the Hunter color system. The results are shown in Table 3.

Blue transit was also evaluated. The blue transit is expressed by Δb=b₂₄−b₀, wherein b₂₄ and b₀ have the same meanings as defined above. The results are shown in Table 3.

TABLE 3

| | Zinc | Potassium | Iodine | Zinc | Zinc | | | | |
|---|---|---|---|---|---|---|---|---|---|
| | Content | Content | Content | Content/Potassium | Content/Iodine | | | | |
| | (%) | (%) | (%) | Content | Content | ΔEab_{80/90-120} | Δb | ΔEab₁₀₀ | Δb |
| Example 1 | 0.081 | 1.124 | 4.826 | 0.072 | 0.0168 | 0.86 | −0.52 | — | — |
| Example 2 | 0.085 | 0.956 | 4.059 | 0.088 | 0.0208 | 4.58 | −2.64 | — | — |
| Example 3 | 0.090 | 0.999 | 4.287 | 0.090 | 0.0209 | 3.22 | −2.24 | — | — |
| Comparative | 0.000 | 0.780 | 3.090 | 0.000 | 0.0000 | 7.90 | −3.71 | — | — |
| Example 1 | | | | | | | | | |
| Comparative | 0.040 | 0.930 | 3.700 | 0.043 | 0.0108 | 7.60 | −3.30 | — | — |
| Example 2 | | | | | | | | | |
| Comparative | 0.214 | 0.873 | 4.060 | 0.245 | 0.0527 | 8.68 | −4.14 | — | — |
| Example 3 | | | | | | | | | |
| Comparative | 0.402 | 0.751 | 3.982 | 0.536 | 0.1010 | 10.26 | −4.39 | — | — |
| Example 4 | | | | | | | | | |
| Comparative | 0.526 | 0.748 | 4.161 | 0.703 | 0.1264 | 11.69 | −4.65 | — | — |
| Example 5 | | | | | | | | | |
| Comparative | 0.262 | 0.092 | 1.476 | 2.848 | 0.178 | — | — | 13.26 | −5.64 |
| Example 6 | | | | | | | | | |
| Comparative | 0.129 | 0.113 | 1.125 | 1.142 | 0.115 | — | — | 12.55 | −5.58 |
| Example 7 | | | | | | | | | |

Table 3 and FIG. 1 and 2 indicate that: the polarizers of Examples 1 to 3 according to the invention satisfy all the requirements of the value of zinc content/potassium content (from 0.05 to 0.4), the potassium content (from 0.2 to 12% by weight), the value of the zinc content/iodine content (from 0.012 to less than 0.05), and the iodine content (from 1 to 20% by weight); the color difference ΔEab_{80/90-120} in the perpendicular state at high temperature and increased humidity can be 5 or less in Examples 1 to 3; and the change in hue is smaller in Examples 1 to 3 than in Comparative Examples 1 to 5 that satisfy none of the requirements. Table 3 and FIG. 3 also indicate that Examples 1 to 3 can satisfy the requirement −3≦b≦0 and can prevent blue transit and that Comparative Examples 6 or 7 does not achieve even high-temperature durability.

### With Respect to Examples 11 to 17 and Comparative Examples 11 to 16

[Evaluation of Polaization Properties]

Optical characteristics (single transmittance, degree of polarization and dichroic ratio) of the obtained polarizing plates were determined by the methods below. The results are shown in Table 4.

<Single Transmittance: Ts>

The transmittance is a Y value determined with a spectrophotometer (DOT-3 manufactured by Murakami Color Research Laboratory) through relative spectral responsibility correction by the CIE 1931 standard calorimetric system according to JIS Z 8701 (C light).

Degree of Polarization: Pz>

A transmittance (H₀) of the same two polarizing plates superimposed with their polarization axes arranged parallel and a transmittance (H₉₀) of those superimposed with their polarization axes arranged perpendicular were determined, respectively, according to the above transmittance measuring method, and the degree of polarization was calculated using the formula below. The parallel transmittance (H₀) and the perpendicular transmittance (H₉₀) are each a Y value determined through relative spectral responsibility.
Degree of Polarization (%)={(H₀−H₉₀)/(H₀+H₉₀)}^{1/2}×100
<Dichroic Ratio>

The dichroic ratio was calculated using the single transmittance (Ts) and the degree of polarization (Pz) according to the formula below. Herein, the dichroic ratio is defined by the following formula:
Dichroic ratio=log{(Ts/100)−(Ts·Pz/100·100)}/log{(Ts/100)+(Ts·Pz/100·100)}
Durability Test Evaluation]

The resulting polarizing plates were tested for high-temperature durability and high-temperature and high-humidity durability by the methods below. The results are shown in Table 4.

<High Temperature Durability>

The polarizing plate was allowed to stand at 110° C. for 24 hours, and then its color difference ΔEab₁₁₀ was determined. The color difference ΔEab₁₁₀ in the perpendicular state was determined using the initial chromaticity (L₀,a₀,b₀) in the perpendicular state and the chromaticity (L₂₄,a₂₄,b₂₄) in the perpendicular state after standing at 110° C. for 24 hours according to the following formula: ΔEab₁₁₀={(L₂₄−L₀)²+(a₂₄−a₀)²+(b₂₄−b₀)²}^{1/2.} The L value, the a value and the b value are according to the Hunter color system.

High-Temperature and High-Humidity Durability>

The polarizing plate was allowed to stand under the conditions of 80° C. and 90% RH for 24 hours, and then its color difference ΔEab_{80/90-24} was determined. The color difference ΔEAb_{80/90-24} in the perpendicular state was determined using the initial chromaticity (L₀,a₀,b₀) in the perpendicular state and the chromaticity (L₂₄,a₂₄,b24) in the perpendicular state after standing under the conditions of 80° C. and 90% RH for 24 hours according to the following formula: ΔEab_{80/90-24}=((L₂₄−L₀)²+(a₂₄−a₀)²+(b₂₄−b₀)²}^{1/2}. The L value, the a value and the b value are according to the Hunter color system.

Durability>

In order to determine whether both of high-temperature durability and high-temperature and high-humidity durability are achieved, the durability value was calculated with ΔEab₁₁₀ and ΔEab_{80/90-24} by the following formula: ΔEab={(ΔEab₁₁₀)²+(ΔEab_{80/90-24})²}^{1/2}

TABLE 4

| | | | | Zinc | | | | | | | |
|---|---|---|---|---|---|---|---|---|---|---|---|
| | Zinc | Potassium | Iodine | Content/ | Zinc | Single | Degree of | | | | |
| | Content | Content | Content | Potassium | Content/Iodine | Transmittance | Polarization | Dichroic | | | |
| | (%) | (%) | (%) | Content | Content | (%) | (%) | Ratio | ΔEab₁₁₀ | ΔEab_{80/90-24} | ΔEab |
| Example 11 | 0.049 | 0.469 | 2.306 | 0.104 | 0.0212 | 44.35 | 99.91 | 65.0 | 1.80 | 1.48 | 2.33 |
| Example 12 | 0.038 | 0.638 | 2.927 | 0.060 | 0.0130 | 44.13 | 99.93 | 64.2 | 1.68 | 2.76 | 3.23 |
| Example 13 | 0.088 | 0.470 | 2.526 | 0.187 | 0.0348 | 44.44 | 99.93 | 68.7 | 1.13 | 0.36 | 1.18 |
| Example 14 | 0.066 | 0.835 | 3.647 | 0.079 | 0.0181 | 44.46 | 99.91 | 66.7 | 4.70 | 1.79 | 5.03 |
| Example 15 | 0.061 | 0.425 | 2.278 | 0.144 | 0.0268 | 43.99 | 99.90 | 60.4 | 2.24 | 0.31 | 2.26 |
| Example 16 | 0.088 | 0.440 | 2.246 | 0.182 | 0.0356 | 44.57 | 99.88 | 65.0 | 0.66 | 1.92 | 2.03 |
| Example 17 | 0.058 | 0.221 | 1.501 | 0.262 | 0.0386 | 44.04 | 99.92 | 62.8 | 4.74 | 2.75 | 5.48 |
| Comparative | 0 | 0.531 | 2.394 | 0 | 0 | 44.47 | 99.92 | 67.9 | 1.54 | 6.89 | 7.06 |
| Example 11 | | | | | | | | | | | |
| Comparative | 0.038 | 0.070 | 1.040 | 0.543 | 0.0365 | 44.10 | 99.85 | 57.9 | 6.98 | 7.62 | 10.33 |
| Example 12 | | | | | | | | | | | |
| Comparative | 0.019 | 0.809 | 3.405 | 0.023 | 0.0056 | 44.50 | 99.94 | 69.7 | 2.54 | 24.51 | 24.64 |
| Example 13 | | | | | | | | | | | |
| Comparative | 0.059 | 0.069 | 1.034 | 0.855 | 0.0571 | 43.87 | 99.82 | 54.4 | 11.94 | 9.96 | 15.55 |
| Example 14 | | | | | | | | | | | |
| Comparative | 0.032 | 0.837 | 3.538 | 0.038 | 0.0090 | 44.28 | 99.94 | 67.1 | 5.37 | 5.74 | 7.89 |
| Example 15 | | | | | | | | | | | |
| Comparative | 0.063 | 0.039 | 0.984 | 1.615 | 0.0640 | 43.40 | 99.90 | 54.6 | 8.88 | 8.24 | 12.12 |
| Example 16 | | | | | | | | | | | |

Table 4 indicates that: the polarizers of Examples 11 to 17 according to the invention satisfy all the requirements of the value of zinc content/potassium content (from 0.05 to 0.4), the potassium content (from 0.2 to 12% by weight), the value of the zinc content/iodine content (from 0.012 to less than 0.05), and the iodine content (from 1 to 20% by weight); both of the color difference ΔEab₁₁₀ in the perpendicular state at high temperature and the color difference ΔEab_{80/80-24} in the perpendicular state at high temperature and increased humidity can be 5 or less in Examples 11 to 17; and the change in hue is smaller in Examples 11 to 17 than in Comparative Examples 11 to 16 that satisfy none of the requirements, though the polarization characteristics are substantially the same between Examples 11 to 17 and Comparative Examples 11 to 16. The color difference is preferably 3 or less, more preferably 1 or less.

1. A polarizer comprising a zinc-containing polyvinyl alcohol-based film which has been subjected at least to dyeing with an iodine solution containing iodine and potassium iodide, wherein
the polarizer has a value of zinc content (% by weight)/potassium content (% by weight) of from 0.05 to 0.4, and a potassium content of from 0.2 to 12% by weight, and a value of zinc content (% by weight)/iodine content (% by weight) of from 0.012 to less than 0.05, and an iodine content of from 1 to 20% by weight.

2. A method of producing the polarizer of claim 1, comprising at least the steps of performing to a polyvinyl alcohol-based film: uniaxial stretching; iodine dyeing with an iodine solution containing iodine and potassium iodide; zinc impregnating with a zinc salt solution; and washing with a potassium iodide solution after the above steps, wherein the zinc salt solution has a zinc ion concentration (B) of from 0.16 to 1% by weight in the zinc impregnating step, and
(A), (B) and (C) are adjusted so as to satisfy the formula: −(B/A)+6>C>−3×(B/A)+5.5 wherein (A) represents a potassium iodide concentration (% by weight) of the iodine solution in the iodine dyeing step, (B) represents a zinc ion concentration (% by weight) of the zinc salt solution in the zinc impregnating step, and (C) represents a potassium iodide concentration (% by weight) of the potassium iodide solution in the washing step.

3. A polarizing plate, comprising the polarizer according to claim 1 and a transparent protective layer formed on at least one side of the polarizer.

4. The polarizing plate according to claim 3, wherein the polarizing plate has a color difference ΔEab_{80/90-120} of 5 or less, wherein ΔEab_{80/90-120} is defined by the following formula:
ΔEab_{80/90-120}={(L₁₂₀−L₀)²+(a₁₂₀−a₀)²+(b₁₂₀−b₀)²}^{1/2}
wherein (L₀,a₀,b₀) is an initial chromaticity in an perpendicular state, (L₁₂₀,a₁₂₀,b₁₂₀) is a chromaticity after the polarizing plate is allowed to stand under the conditions of 80° C. and 90% RH for 120 hours, and the L value, the a value and the b value are according to the Hunter color system.

5. An optical film, comprising at least the polarizer according to claim 1.

6. An image display, comprising at least the polarizer according to claim 1.

7. An image display, comprising at least the optical film according to claim 5.

8. An optical film, comprising at least the polarizing plate according to claim 3.

9. An optical film, comprising at least the polarizing plate according to claim 4.

10. An image display, comprising at least the polarizing plate according to claim 3.

11. An image display, comprising at least the polarizing plate according to claim 4.

12. An optical film, comprising at least the optical film according to claim 8.

13. An optical film, comprising at least the optical film according to claim 9.
